(19) United States
(12) Patent Application Publication
(10) Pub. No.: US 2013/0147583 A1
(43) Pub. Date: Jun. 13, 2013

(54) BISTABLE ELECTROMAGNETIC ACTUATING DEVICE AND CAMSHAFT ACTUATING DEVICE

(71) Applicant: ETO MAGNETIC GmbH, Stockach (DE)

(72) Inventors: Thomas Schiepp, Seitingen-Oberflacht (DE); Joerg Buerssner, Engen (DE)

(73) Assignee: ETO MAGNETIC GMBH, Stockach (DE)

(21) Appl. No.: 13/693,588

(22) Filed: Dec. 4, 2012

(30) Foreign Application Priority Data
Dec. 7, 2011 (DE) 20 2011 052 220.2

(51) Int. Cl. F01L 1/46; H01F 7/08

(52) U.S. Cl. CPC F01L 1/46; H01F 7/08
USPC 335/229

(57) ABSTRACT

A bistable electromagnetic actuating device and a camshaft actuating device for displacing a camshaft in a motor vehicle having an electromagnetic actuating device.

### BACKGROUND OF THE INVENTION

The invention relates to a bistable electromagnetic actuating device and a camshaft actuating device for displacing a camshaft in a motor vehicle having an electromagnetic actuating device.

Such generic actuating devices are known and described for example in DE 10 240 774 B4 or DE 20 2006 011 905 U1. In contrast to conventional actuating devices, the above electromagnetic actuating devices do not have a restoring spring, so the actuating-element-side permanent magnet means with the actuating element does not have to be accelerated counter to the force of such a restoring spring. Substantially improved switching times and improved switching dynamics result from this. The disc-shaped permanent magnet means are used to hold the actuating element securely in the housing in a (retracted) rest state by interaction with the core region. The actuating-element-side permanent magnet means also have a repulsion effect when the coil device is excited to produce an electromagnetic counter field and thus causes the actuating element to be driven out of an associated housing, as the electromagnetic counter field produced with the counter force has a repulsive effect on the permanent magnet means and thereupon produces the advancement of the actuating element. The known bistable electromagnetic actuating devices have proven effective, but problems have arisen in the design. For instance, the actuating element with associated permanent magnet means is accelerated greatly and also braked extremely on impact for each stop. As permanent magnet means are generally comparatively brittle, the mechanical stability can be endangered at even faster switching speeds. The weld seams with which the pole discs associated with the permanent magnet means are fastened to the actuating element are also subject to high stresses.

Proceeding from the above-mentioned prior art, the invention is based on the object of reducing the mechanical stress of the actuating element assembly, comprising the permanent magnet means in a bistable actuator without having to resort to conventional restoring springs as are installed in proportional magnetic actuating devices, as the said restoring springs also have a negative effect on the switching time and the switching dynamics. This could in turn only be compensated with a larger design, which must be avoided in motor vehicles owing to installation space problems. Furthermore, the object consists in specifying a camshaft displacement device having a correspondingly improved bistable electromagnetic actuating device for applications in the motor vehicle engine field.

### SUMMARY OF THE INVENTION

This object is achieved with a bistable electromagnetic actuating device, and a camshaft actuating device.

The invention is based on the concept of providing damping means instead of a restoring spring which acts over the entire stroke, which damping means are formed and arranged in such a manner that they have a damping effect only at the end of the actuating element stroke. In other words, in a bistable electromagnetic actuating device according to the invention, which preferably does not have a restoring spring, damping means are provided for damping the impact when the first and/or second switch position is reached, which means do not have a damping effect over the whole displacement distance, but only in an end section of the displacement movement, which can be achieved for example in that the damping elements have an axial extent which is shorter than the displacement travel, so that the damping means are compressed and apply their damping force after a certain displacement distance has been covered. This advantageously means that the impact energy of the armature assembly comprising the permanent magnet means, the pole discs and the actuating element is reduced not over the whole displacement distance, but only in an end section, as a result of which negative effects on the switching time and switching dynamics are minimised. In particular, the actuating device does not have to have a larger size, and a restoring spring, which would have a negative effect, can be omitted. It is particularly advantageous to provide damping means which damp the impact in the second switch position, that is, the impact when the actuating element, which preferably forms an engagement region at the end, is extended, in particular in the groove of an axially displaceable cam arrangement of a camshaft. Additionally or alternatively, damping means can be provided which damp the impact when the first switch position is reached, that is, when the actuating element is displaced in the direction of the core region. It is particularly expedient if the bistable electromagnetic actuating device is designed for comparatively short displacement paths, of preferably less than 10 mm, in particular less than 5 mm, wherein the damping means correspondingly have an effect only over a section, which is in particular comparatively short, of the said displacement distance.

The armature assembly can be displaced between a first stop face, which is preferably formed by the stationary core region, and a second stop face, which is formed for example by the end face of an actuating element guide tube and/or by a housing part. A (first or second) stop face primarily means a support face on which the armature assembly is (directly or indirectly) supported when it reaches the first or second switch position. If damping means are provided for damping the impact in the respective switch position, the armature assembly is supported by means of the said damping means on the rigid, non-compressible stop face, it being possible for damping means to be arranged on the stop face (supporting face) and/or on a corresponding counter-face of the armature assembly. If damping means are not provided for damping the impact in the first or second switch position, the armature assembly is supported directly (but in an undamped manner) on the stop face.

The first and/or second stop face(s) is/are preferably positioned and formed in such a manner that relatively large natural vibrations are prevented.

The damping means are preferably fastened in a force- or form-fitting manner, or else in a materially cohesive manner, for example by welding, to a holding face, which is for example formed by a pole disc.

It is particularly expedient if the damping means are formed and arranged in such a manner that they can be loaded with force, in particular compressed, in the direction of the first and/or second switch position only in the end section of the displacement movement. The damping means are preferably correspondingly short for this purpose and come into contact with the assembly being moved (armature assembly) only towards the end of the displacement movement in an arrangement on the armature assembly or in an arrangement on the armature assembly with stationary parts. The damping means are preferably relaxed during the displacement movement which is not loaded with force, preferably over most of the displacement movement, i.e. more than 50% of the displacement distance.

It is especially expedient to design the axial extent of the end section of the displacement distance in which the damping means can be loaded with force, in particular compressed in such a manner that the said end section corresponds to less than 50%, preferably less than 40%, even more preferably less than 30% of the whole displacement stroke. For the specific use of the bistable electromagnetic actuating device in a camshaft displacement device, it is advantageous if the axial extent of the said end section of the displacement stroke is less than 3 mm, preferably less than 2 mm, very preferably approximately 1 mm or less.

With respect to the actual arrangement of the damping means, there are different possibilities. It is particularly expedient if the damping means are arranged in a displaceable manner together with the actuating element, i.e. together with the armature assembly. In this manner, damping means can be arranged in a supporting manner for example on a pole disc facing the second stop face and/or on a pole disc oriented in the direction of the first stop face. Additionally or alternatively, damping means arranged at least on one stop face can be provided, which do not move together with the armature assembly, but come into contact with the latter and/or with damping means optionally moved together with the latter only in the end section of the stroke movement. If the damping means are arranged on the armature assembly, it is advantageous if the damping means are axially supported on one of the pole discs associated with the permanent magnet means. Additionally or alternatively, the damping means can be arranged in a supporting manner on a radial projection of the actuating element and/or on the end face of the actuating element.

It is particularly advantageous if the damping means are arranged in a ring-shaped manner around the actuating element, that is, are penetrated by the actuating element. It has been found to be particularly expedient if the axial extent of the damping means, which extends in the displacement direction, is less than the radial extent which is oriented perpendicularly thereto; in other words, the (outer) diameter of the preferably ring-shaped damping means is much greater than the axial extent thereof.

With respect to the actual formation of the damping means, there are different possibilities. For instance, it is conceivable to form spring elements from metal and/or plastic. These are resilient preferably just because of the spring geometry thereof and consist of a non-elastically compressible material. It is also conceivable to use damping elements consisting of an elastically deformable material, for example damping elements consisting of rubber and/or in particular foamed elastomer material. It is also particularly expedient to combine different damping elements in order to influence the damping properties. For example, a spring element consisting of a rigid material can be combined with an elastomer material damping element, as a result of which the delay in the movement of the actuating element can take place in two stages. The spring element preferably initially delays to a (residual) speed of more than zero, the remaining movement energy then being absorbed by the elastomer material element. With a combination of different damping elements, it is advantageous to use a damping element, the spring force of which initially increases, in particular continuously, on compression and collapses from a certain point (clicker), while the force profile of the further damping element increases, for example continuously, over the entire displacement path. In any case it is particularly preferred if at least two of the plurality of damping means differ in their spring behaviour (characteristic behaviour).

With respect to the actual design of damping elements of the damping means, there are different possibilities. For instance, it is possible and advantageous to provide what are known as topographic springs, in particular ring-shaped ones, in particular in a wave shape, which can produce a counter-force which damps the impact at a very short distance. It is also possible to provide damping elements in the form of plate springs, which can produce and absorb large forces at an extremely small distance. At least one damping element, in particular a plate spring, is preferably designed in such a manner that it absorbs as much kinetic energy as possible at the start of a force effect and collapses after a certain point and then effects hardly any counter-forces. This design has the advantage that the spring force is low in the first and/or second switch position and thus the retaining force produced by the permanent magnet means is maximal. Conversely, a damping element designed in such a manner has the advantage that it has an accelerating (assisting) effect from a certain stroke and thus has a positive influence on the switching dynamics. In order to have as little influence as possible on the magnetic field, a damping element comprising or consisting of beryllium and/or at least one beryllium alloy could for example be used.

It is also possible to use a diaphragm spring as at least one damping element. The use of plate or diaphragm springs makes it possible and preferred to maintain a spring characteristic which behaves initially progressively over the stroke region and only behaves degressively in the last part of the stroke.

The provision of elastomer material elements means that the system can be made “softer”, in particular in combination with a further, preferably metallic spring element. The delay path can be selected/designed in such a manner that the accelerations are precisely the right magnitude for connection points such as weld seams to withstand the stresses safely throughout the service life.

### BRIEF DESCRIPTION OF THE DRAWINGS

Further advantages, features and details of the invention can be found in the description below of preferred exemplary embodiments, as well as on the basis of the drawings.

FIG. 1 shows a first exemplary embodiment of a bistable electromagnetic actuating device as part of a camshaft displacement device (not shown in detail) having damping means supported on pole discs of an armature assembly,

FIG. 2 shows an alternative exemplary embodiment of a bistable actuating device, damping means being provided in this case which are only oriented in the direction of a second stop face,

FIG. 3 shows a perspective view of an armature assembly (piston-shaped actuating element), permanent magnet means, pole discs having damping means which are formed on a pole disc and formed as a wave spring,

FIG. 4 shows a damping element formed as a plate spring,

FIG. 5 shows an exemplary embodiment of a damping element formed as a diaphragm spring,

FIG. 6 shows an alternative diaphragm spring element, and

FIG. 7 shows by way of example the combination of a diaphragm spring element and a plate spring element.

### DETAILED DESCRIPTION

In the figures, identical elements and elements having identical functions are provided with the same reference symbols.

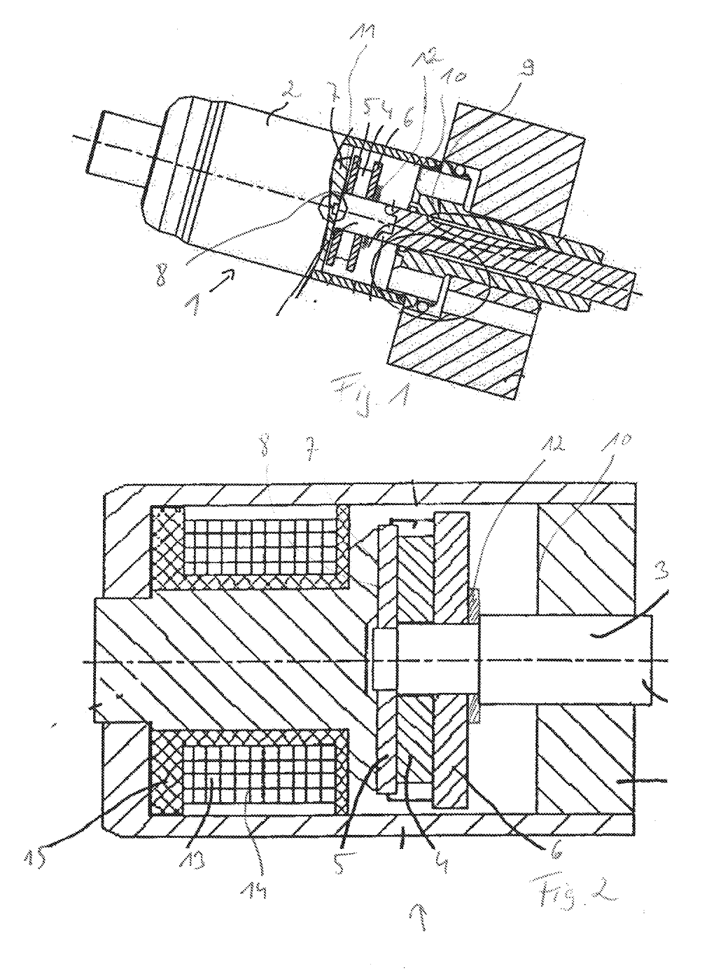

FIG. 1 shows a bistable electromagnetic actuating device 1, which interacts in an actuating manner with an actuating partner (not shown), in particular a camshaft stroke switching system. The actuating device 1 comprises a hollow-cylindrical, magnetically conductive bushing element 2, inside which an elongated, piston-shaped actuating element 3 is arranged. The actuating element 3 penetrates disc-shaped permanent magnet means 4, which are arranged between a first and a second magnetically conductive pole disc 5, 6. The pole discs 5, 6 are welded to the piston-shaped actuating element 3. In the actual exemplary embodiment, the pole discs 5, 6 have a larger radial extent but a smaller thickness extent than the permanent magnet means 4. The actuating element 3 can be moved between a stationary core region 7, which forms a first stop face 8, and a sleeve-shaped bearing element 9, which acts as a yoke and forms a second stop face 10. The two stop faces 8, 10 delimit end stops for the armature assembly formed from the actuating element 3, the permanent magnet means 4 and the pole discs 5, 6. The actuating element 3 of the said armature assembly has an engagement region at the end of the end projecting out of the housing, for engagement in a circumferential groove in a cam which can be displaced on a camshaft.

The core region 7 is part of a coil device 13 (not shown), which is arranged inside the bushing element 2 in the left-hand half of the drawing and which, when supplied with current, causes the actuating element 3 to be displaced from the first switch position shown, away from the core region 7, into the second switch position defined by the second stop face 10, by producing a magnetic field.

In FIG. 1 it can be seen that the armature assembly and thus the actuating element 3 are assigned first and second damping means 11, 12, the first damping means 11 being supported axially on the first pole disc and extending in the direction of the core region 7 and the second damping means 12 being supported axially on the second pole disc 6 and extending in the direction of the stroke switching system (not shown) in the exemplary embodiment shown. The first damping means 11 are used to interact directly with the first stop face 8 in order to damp the impact of the armature assembly on the first stop face 8 or in the first switch position 8. The second damping means which can be displaced together with the actuating element 3 like the first damping means 11 are used to stop or interact with the second stop face 10 and have the function of damping the impact in the second switch position. Alternatively, it is also possible to provide only first or only second damping means 11, 12. As mentioned, the damping means 11, 12 can be moved together with the actuating element 3 and are therefore part of the armature assembly in the exemplary embodiment shown. Additionally or alternatively, damping means 11, 12 can be provided on the first and/or second stop face 8, 9. It is essential that the damping means 11, 12 are such in their axial extent that they have a damping effect only at the end of the displacement movement, i.e. of the displacement stroke, in order to ensure good switching dynamics. A restoring spring which has a spring effect over the entire displacement distance has been deliberately omitted.

FIG. 2 shows an alternative actuating device 1. The actuating element 3 can be seen with the permanent magnet means 4 arranged thereon, to which are assigned a first and a second pole disc 5, 6, the pole discs 5, 6 being dimensioned differently in the exemplary embodiment shown. Only two damping means 12 for damping the impact in the second switch position can be seen. These are axially penetrated by the actuating element 3 as in the exemplary embodiment of FIG. 1 and are supported at the end on the second pole disc 6. First damping means 11 have been omitted in the exemplary embodiment shown. In the exemplary embodiment shown, the first stop face 8 formed by the core region 7 interacts directly with the first pole disc 5. Alternatively, the core region 7 can be designed in such a manner that the armature assembly is supported on the first stop face 8 directly by means of the actuating element 3. As in the exemplary embodiment of FIG. 1, the pole discs 5, 6 are fastened by welding to the actuating element 3 penetrating them.

In contrast to FIG. 1, a coil device 13 can be seen, comprising a winding 14 which is arranged on a coil carrier 15. Additionally and alternatively to the second damping means 12, first damping means 11 could also be provided in the exemplary embodiment of FIG. 2, which can be arranged fixedly on the first stop face 8, or preferably can be displaced together with the actuating element 3, in particular by fastening the first damping means 11 to the first pole disc 5.

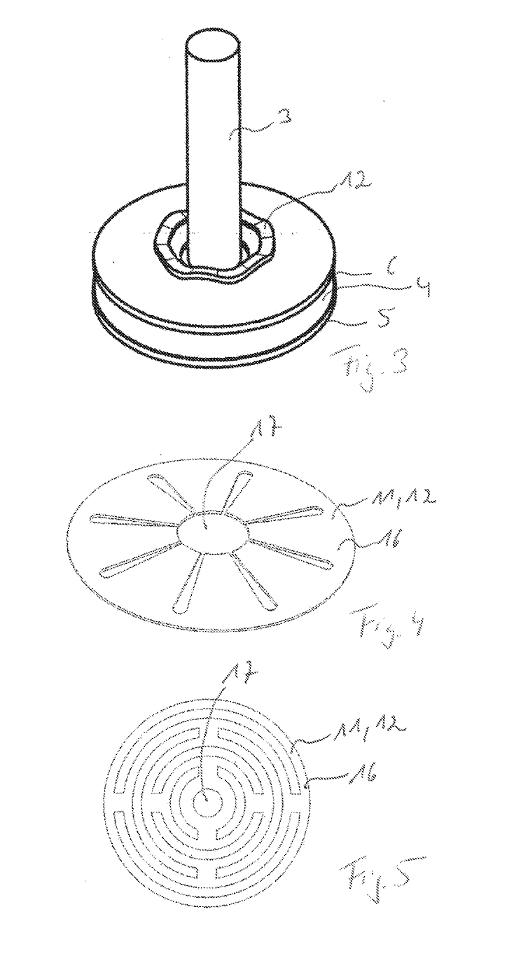

FIG. 3 shows an armature assembly by itself, comprising a piston-shaped actuating element 3 with pole discs 5, 6 fastened thereon at a distance from each other, which enclose permanent magnet means 4 between them. Second damping means 12 can be seen, which are supported axially on the second pole disc 6 and are preferably fastened to latter, for example by welded points. In the exemplary embodiment shown, the damping means 11, 12 consist of a metallic wave spring, the axial extent of which is much smaller than the displacement distance, so the damping means 11, 12 which can be displaced together with the actuating element 3 come into contact with the second stop face 10 and thus have a damping effect only at the end of the stroke movement.

FIG. 4 shows an alternative damping element 16, which by itself or in combination with further damping elements 16 can form first and/or second damping means 11, 12. It can be seen that the damping element 16 is formed as a metallic plate spring, which is formed as a punched/bent part and preferably has a non-linear spring behaviour. The plate spring has a central opening 17 for the actuating element 3 and is in one part but divided into a plurality of circular-segment-shaped spring sections, which are separated from each other by radial cuts proceeding from the opening 17 towards the circumference.

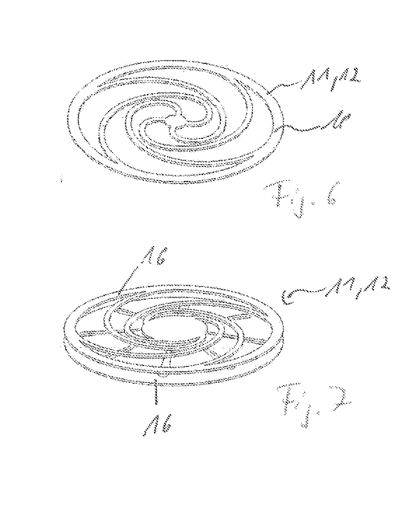

FIG. 5 shows an alternative damping element 16, which by itself or in combination with further, preferably different damping elements 16 can form damping means 11, 12. The damping element 16 according to FIG. 5 is formed as what is known as a diaphragm spring, which preferably has a spring characteristic which over the stroke region runs initially at least approximately linearly and then progressively only in the last part of the stroke. The diaphragm spring 16 has a plurality of coaxially arranged part-circle cut-outs, which are arranged around a central opening 17 for receiving the actuating element 3.

FIG. 6 shows an alternative embodiment of a diaphragm spring having a radially inner, central section and an outer ring section, the central section and the ring section being connected to each other by means of spring arms running in the radial direction and in the circumferential direction.

FIG. 7 shows damping means 11, 12 which are formed by two different damping elements 16, in the actual exemplary embodiment by a plate spring (lower in the drawing plane) and an axially adjacent diaphragm spring which is preferably fastened to the plate spring.

1. A bistable electromagnetic actuating device, in particular for displacement of a camshaft in a motor vehicle, comprising an actuating element which forms an engagement region and can be moved between a first and a second switch position, a coil device which is provided in a stationary manner relative to the actuating element and is formed to exert a force on the actuating element, wherein the actuating element is assigned a disc-shaped permanent magnet element, which is accommodated between magnetically conductive pole discs which are provided on both sides of the permanent magnet means and are fastened to the actuating element, wherein the permanent magnet element is formed to interact with a stationary core region, and the coil device is formed to produce a counter-force which counteracts a holding force of the permanent magnet element and loads the latter with a force together with the actuating element away from a first stop face formed by the core region towards a second stop face which defines the second switch position, damping means associated with the actuating element are provided for damping the impact when the first and/or second switch position is reached, the damping means are formed and arranged in such a manner that they have a damping effect only in an end section of the displacement movement of the actuating element from the first switch position to the second switch position and/or from the second switch position to the first switch position.

2. The actuating device according to claim 1, wherein the damping means are formed and arranged in such a manner that they can be elastically deformed only in the end section of the displacement movement.

3. The actuating device according to claim 2, wherein an axial extent of the end section of the displacement distance in which the damping means can be elastically deformed is less than 50% of the axial extent of the displacement movement and/or that the axial extent of the end section is less than 3 mm.

4. The actuating device according to claim 1, wherein the damping means are arranged such that they can be displaced together with the actuating element.

5. The actuating device according to claim 1, wherein the damping means are arranged on the first stop face and/or on the second stop face.

6. The actuating device according to claim 1, wherein the damping means during the entire displacement movement of the actuating element are arranged such that they are supported axially on the pole disc which is oriented in the direction of the second stop face and/or axially on the pole disc which is oriented in the direction of the first stop face and/or on the actuating element, in particular on the end face thereof.

7. The actuating device according to claim 1, wherein the damping means are penetrated axially by the actuating element.

8. The actuating device according to claim 1, wherein the axial extent of the damping means, which extends in a displacement direction, is smaller than the radial extent thereof, which is oriented perpendicularly thereto.

9. The actuating device according to claim 1, wherein the damping means comprise a damping element which is formed as a spring.

10. The actuating device according to claim 9, wherein the damping means comprise one of a plate spring, a wave spring, a diaphragm spring, and a clicker spring.

11. The actuating device according to claim 1, wherein the damping means comprise a damping element consisting of an elastomer material.

12. The actuating device according to claim 1, wherein the damping means comprise a combination of at least two identical and/or at least two different damping elements selected from a metal spring element and an elastomer element.

13. A camshaft displacement device for operating a cam arrangement having at least one circumferential groove of a camshaft, having a bistable electromagnetic actuating device comprising an actuating element which forms an engagement region and can be moved between a first and a second switch position, a coil device which is provided in a stationary manner relative to the actuating element and is formed to exert a force on the actuating element, wherein the actuating element is assigned a disc-shaped permanent magnet element, which is accommodated between magnetically conductive pole discs which are provided on both sides of the permanent magnet means and are fastened to the actuating element, wherein the permanent magnet element is formed to interact with a stationary core region, and the coil device is formed to produce a counter-force which counteracts a holding force of the permanent magnet element and loads the latter with a force together with the actuating element away from a first stop face formed by the core region towards a second stop face which defines the second switch position, damping means associated with the actuating element are provided for damping the impact when the first and/or second switch position is reached, the damping means are formed and arranged in such a manner that they have a damping effect only in an end section of the displacement movement of the actuating element from the first switch position to the second switch position and/or from the second switch position to the first switch position, wherein the actuating element of the actuating device engages with the engagement region thereof in the groove when in the second switch position and can be displaced from the second switch position into the first switch position by the rotary movement of the camshaft.
